(19) United States
(12) Patent Application Publication
(10) Pub. No.: US 2009/0055382 A1
(43) Pub. Date: Feb. 26, 2009

(54) Automatic Peer Group Formation for Benchmarking

(75) Inventor: Florian Kerschbaum, Karlsruhe (DE)

Correspondence Address: BRAKE HUGHES BELLERMANN LLP, C/O INTELLEVATE, P.O. BOX 52050, MINNEAPOLIS, MN, 55402, US

(73) Assignee: SAP AG, Walldorf (DE)

(21) Appl. No.: 11/844,114

(22) Filed: Aug. 23, 2007

(51) Int. Cl. G06F 7/00

(52) U.S. Cl. 707/5; 707/E17.014

(57) ABSTRACT

A method of automatically generating peer groups of entities includes receiving data for a plurality of characteristic parameters about a number of entities and defining a number of peer groups, k, to be generated. A minimum number of entities, m, to be assigned to each peer group is defined, and k initial cluster values are defined around which to group the entities according to the data for the entity's characteristic parameters. Each entity is assigned to a peer group associated with a particular initial cluster center value, and it is ensured that the number of entities assigned to each peer group is greater than the minimum number, m.

### TECHNICAL FIELD

This description relates to techniques for peer group formation and, in particular, to automatic peer group formation for benchmarking.

### BACKGROUND

Businesses often wish to compare their performance, according to various metrics, to the performance of other similar business. Thus, businesses often benchmark their key performance indicators (KPI) against similar businesses to gauge their performance against competitors, where KPI is a statistical quantity measuring the performance of a business process. To perform benchmarking, KPI data is collected from a number of companies in a peer group of similar companies, and statistical analyses are performed on the data to determine representative KPI values for the peer group to which a company can compare its particular KPI data.

Benchmarking within a peer group of multiple companies can be done anonymously. That is, each company within a peer group may share its own particular KPIs with an entity that performs the statistical analysis on the group's data, and each member of the group can have access to the aggregate KPI data of its peer group. However, to assure anonymity, companies must not be able deduce the data belonging to any specific competitor from this aggregate data, and association of particular KPI data with a particular company must remain private, even to the entity that performs the statistical analysis. To preserve privacy and facilitate effective benchmarking, the peer groups among which KPI are evaluated may have certain similar characteristics.

Providing a benchmarking service for a large number of customers (e.g., on the order of thousands or hundreds of thousands of customers), each of which may supply a large amount of KPI data to the benchmarking service, and, in particular, organizing the different customers into different peer groups, represents a challenging computational problem. Existing linear programming techniques are generally not capable of handing this problem in with realistic computational resources in acceptable times. Moreover, traditional clustering methods may have unwanted side effects, such as empty peer groups, peer groups with too few entities in them (which is problematic because a member of the peer group may be able to deduce the confidential KPI of a competitor from the aggregate benchmarking data), or too many entities for meaningful benchmarking.

### SUMMARY

Thus, techniques and systems are described herein that can be used to generate peer groups automatically from a large number of companies, with constraints placed upon the minimum size of peer groups so that established benchmarking techniques can be applied to the automatically formed peer groups. The techniques and systems described herein are fast and avoid problems associated with linear programming approaches, and therefore are applicable to, and usable on, large, real-world data sets (e.g., involving more than 10,000 companies, more than 1000 peer groups, and more than 100 KPI per company). For example, an algorithm for generating peer groups from a large number of companies can begin by quantifying characteristic information about the companies, the arbitrarily assigning k cluster centers which will function as peer group centers, then assigning data points corresponding to different companies to these clusters based on the quantified companies' characteristic information. Then the location of each cluster center can be revised by averaging the data points associated with that cluster center, and each data point then can be (re)assigned to the cluster whose center is closest to that point. These steps can be repeated until no further change in the assignments occurs and until the cluster centers stabilize. A minimum threshold cluster size can be set, and a non-linear greedy algorithm can be used to dynamically reassign data points from a cluster to a nearby cluster that does not meet the minimum size requirement, enabling the generation of peer group clusters from large amounts of data for business benchmarking and similar applications. Moreover, the additional of incremental data can be handled in such a way as to ensure fast clustering of additional data and to enable rapid delivery of the product of the benchmarking service thousands or hundreds of thousands of customers

In particular, according to one general aspect, a method of automatically generating peer groups of entities includes receiving data for a plurality of characteristic parameters about a number of entities and defining a number of peer groups, k, to be generated. A minimum number of entities, m, to be assigned to each peer group is defined, and k initial cluster values are defined around which to group the entities according to the data for the entity's characteristic parameters. Each entity is assigned to a peer group associated with a particular initial cluster center value, and it is ensured that the number of entities assigned to each peer group is greater than the minimum number, m.

Implementations can include one or more of the following features. For example, ensuring that the number of entities assigned to each peer group is greater than m can include evaluating the number of entities in peer groups, reassigning an entity from a neighboring peer group to a peer group having fewer than m entities, so long as the reassigned entity has not previously be assigned to the peer group having fewer than m entities, and repeating the evaluating and the reassigning until all peer groups include at least m entities. In some implementations, no entity is reassigned more than once. The assignment of each entity to a peer group associated with an initial cluster value can be based on the values of the entity's characteristic parameters and the value of the initial cluster value of the peer group. Data for the characteristic parameters can include key performance indicators (KPI) for the entities. The initial cluster values can be assigned randomly within bounds defined by highest and lowest values of the characteristic parameters.

In some implementations, cluster centers values for peer groups can be modified to reflect values of the characteristic parameters of the entities assigned to the peer groups. Entities can be reassigned to peer groups based upon the values of the entities' characteristic parameters and the cluster center values of the peer groups, including any modified cluster center values. Peer groups can be refined by reassigning entities to peer groups to ensure that the number of entities assigned to each peer group is greater than the minimum number, m. The modification of the cluster values, the reassignment of the entities to the peer groups, and the refining of peer groups can be repeated until the cluster center values change by less than a threshold value during subsequent iterations, and until the number of entities assigned to each peer group is greater than the minimum number, m.

In some implementations, after a plurality of entities have been assigned to a number of peer groups, such that the number of entities assigned to each peer group is greater than m, a new entity to be added to a peer group can be received. The new entity can be assigned to an existing peer group associated with a particular cluster center value based on the new entity's characteristic parameters and the value of the particular cluster center value. When the number of entities assigned to the existing peer group exceeds a maximum size threshold, the existing peer group can be partitioned into two new peer groups, and subsets of the entities from the existing peer group can be assigned to each new peer group. Then a cluster center value associated with each new peer group can be determined.

In some implementations, KPI data can be received for entities. The KPI data can be analyzed to generate benchmark data for a peer group having at least m entities, and the benchmark data can be provided to entities in the peer group. Defining a minimum number of entities, m, to be assigned to each peer group can include defining m to be sufficiently large such that a KPI data value for an entity in a peer group cannot be determined from an average of the KPI data values for all entities in the peer group. For example, the number of entities assigned to each peer group can be greater than 3. The KPI data can be received anonymously.

In another general aspect, a system for automatically generating peer groups of entities can include a communications agent, a clustering engine, a thresholding filter engine, and a refining engine. The communications agent is adapted to receive characteristic parameter data about entities from remote clients. The clustering engine is adapted to generate cluster center values, assign entities to cluster centers to create peer groups of entities, and adjust cluster center values according to the characteristic parameters of the entities assigned to the cluster centers. The thresholding filter engine is adapted to identify peer groups that do not meet specified size thresholds. The refining engine is adapted to reassign an entity from a neighboring peer group to a peer group that does not satisfy a minimum size threshold if the reassigned entity has not previously been assigned to the peer group that does not satisfy the minimum size requirement.

Implementations can include one or more of the following features. For example, the communications agent can include a secure anonymous gateway for the transfer of characteristic parameter data and key performance indicator data for an entity. The refining engine can be further adapted to evaluate the number of entities in different peer groups, reassign an entity from a neighboring peer group to a peer group that does not satisfy the minimum size threshold if the reassigned entity has not previously been assigned to the peer group that does not satisfy the minimum size requirement, and repeat the evaluating and the reassigning until all peer groups satisfy the minimum size threshold, while not reassigning an entity back to a peer group from which the entity was already reassigned. The refining engine can be further adapted to modify cluster center values after reassigning an entity from a neighboring peer group to a peer group that does not satisfy the minimum size threshold.

The communications agent can be further adapted to receive a new entity to be assigned to a peer group after a plurality of entities have been assigned to a number of peer groups, such each peer group satisfies the minimum size threshold, while the clustering engine is further adapted to assign the new entity to an existing peer group associated with a particular cluster center value based on the new entity's characteristic parameters and the value of the particular cluster center value, and while, when the number of entities assigned to the existing peer group exceeds a maximum size threshold, the refining engine is further adapted to partition the existing peer group into two new peer groups, assign subsets of the entities assigned to the existing peer group to each new peer group, and determine a cluster center value associated with each new peer group.

The communications agent can be further adapted to receive key performance indicator (KPI) data about the entities from the remote clients, and the system can further include a benchmarking engine adapted to statistically analyze KPI data for entities in a peer group to generate benchmark information for the entities in the peer group. The system can include an administration module adapted to set the minimum size threshold, such that the number of entities assigned to each peer group that satisfies the minimum size threshold is sufficiently large such that a KPI data value for an entity in a peer group cannot be determined from an average of the KPI data values for all entities in the peer group. The communications agent can be adapted to receive the KPI data anonymously.

The details of one or more implementations are set forth in the accompanying drawings and the description below. Other features will be apparent from the description and drawings, and from the claims

### BRIEF DESCRIPTION OF THE DRAWINGS

FIG. 1 is a schematic diagram of an example system for automatically generating peer groups of entities for benchmarking while preserving a minimum peer group size.

FIG. 2 is a schematic flowchart of a process for automatically generating peer groups of entities for benchmarking, using as input characteristic parameters of a multitude of entities, while preserving a minimum peer group size.

FIG. 3 is a schematic flowchart detailing a process for refining peer groups while preserving a minimum peer group size.

FIG. 4 is a schematic flowchart detailing a process for refining peer groups while preserving a maximum peer group size.

FIGS. 5A, 5B, and 5C are schematic diagrams showing the evolution of a peer groups as they are refined by a greedy algorithm for reassigning entities within existing peer groups and according to a process by which thresholds are enforced on minimum peer group size.

FIG. 6 is a schematic flowchart illustrating a process by which incremental entities are added to existing peer groups without requiring the recalculation of every peer group.

FIG. 7 is a schematic flowchart illustrating a process of automatically generating peer groups of entities.

### DETAILED DESCRIPTION

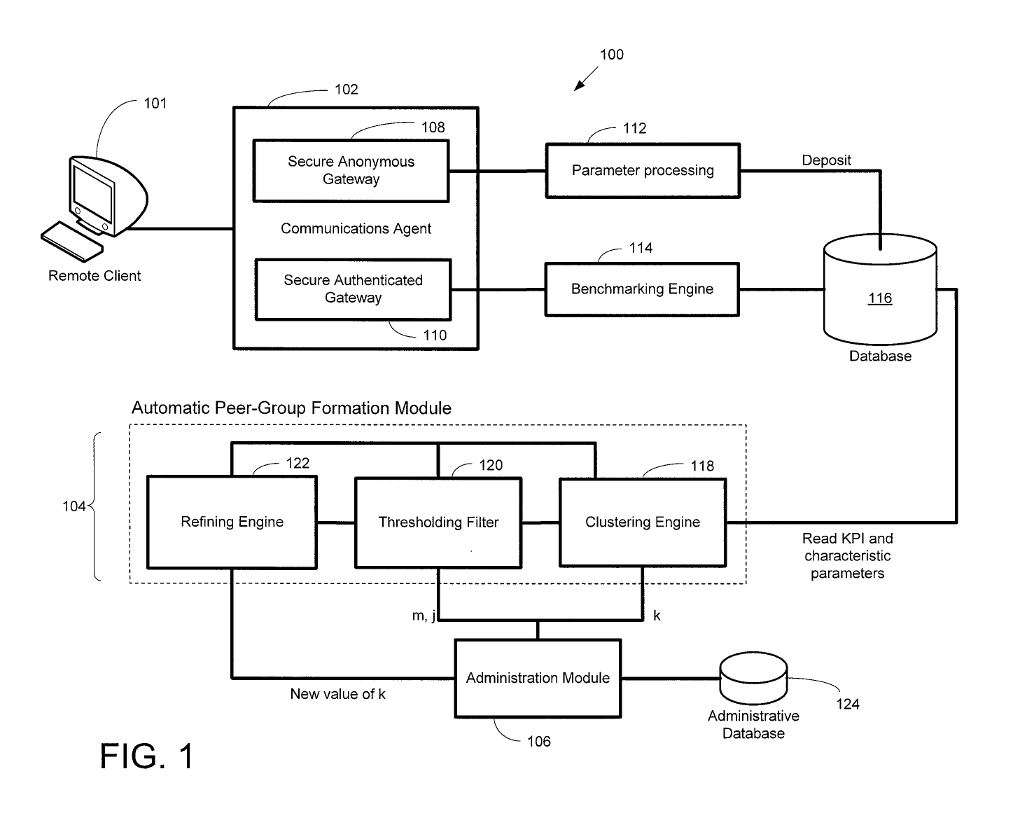

FIG. 1 is a schematic diagram of an example system 100 for automatically generating peer groups of entities for benchmarking. This system can be used to receive characteristic parameters about entities, and to use the received parameters to cluster the entities into peer groups. The entities can be companies, organizations, teams, groups, workers, people, or other objects with characteristic parameters suitable for clustering. Entities can be clustered according to some or all of their characteristic parameters. In an example implementation, the system may group companies into peer groups according to some similar characteristic parameters among the companies.

A peer group can be a group of (usually competing) companies that are interested in comparing their KPIs based on some similarity that exists among the companies. Peer groups can be formed along different characteristics and can include, for example, car manufacturers (representing an industry sector peer group), Standard and Poor's 500 companies in the United States (representing a peer group based on market capitalization and location), or freight haulers, including, for example, airlines, railroads, and trucking companies (representing a peer group based on a sales market).

In one example, the characteristic parameters for competitive companies can include information about the size of the company (e.g., as measured by number of employees, by book value, or market value), information about the location of the company (e.g., as measured by the headquarters, principal place of business, principal markets, etc.), information about the nature of the company's enterprise(s) (e.g., as measured by the type of business the company is involved in—for example, services (e.g., accounting, legal, software, consulting), manufacturing (e.g., autos, textiles, consumer products), mining (gold, aluminum, copper, nickel, crude oil, natural gas, transportation (air, truck, rail, sea). In another example, the characteristic parameters can include information about key performance indicators (KPI) characterizing a company (e.g., as measured by annual revenues or profits, employee retention rate, return on equity, return on investment, salary per average employee, health care costs per employee, etc.).

Entities in a peer group then can compare their own particular key performance indicators (KPI) against characteristic or average KPI for their peer group. In this manner, entities can gauge their standing in the competitive landscape by assessing their KPI against their competitors. In this example implementation, the clustering system assists in identifying and grouping of similarly situated competitors into peer groups so these KPI comparisons are meaningful. Examples of KPI's from different company operations include the cycle time to manufacture a product (which can be relevant to a business's manufacturing or operational performance), the cash flow of a company in a given time period (which can be relevant to a business's financial performance), and an employee retention rate (which relevant to a business's human resources performance).

A benchmarking platform can be operated by a central service provider that offers a database of statistics of peer groups and aggregated KPIs for the peer groups to its customers. Customers, e.g., companies, would first subscribe to the benchmarking service offered by the service provider, and would post their individual KPI data to the service provider or would allow the service provider to retrieve relevant KPI data from the customer. Upon the service provider's request, the subscribed companies would engage in a protocol to regenerate and/or retransmit KPI data to the service provider statistics.

An important aspect of the service provider model is that the subscribed companies only communicate with the service provider, but never amongst each other. Anonymity among the subscribed companies is a desirable feature and can be achieved, if they do not need to exchange messages. The service provider should know the identity of the subscribers for billing purposes.

Central to this system 100 is an Automatic Peer Group Formation Module (APGFM) 104 that receives data about characteristic parameters for a number of entities and assigns a given number (k) of cluster centers for the entities, where each cluster center is described by one or more characteristic parameters. The data about the characteristic parameters can be quantified, so that the cluster centers can be located at quantifiable points within a one- or multi-dimensional space, where the number of spatial dimensions corresponds to the number of characteristic parameters used to locate the points. After assigning cluster centers, the APGFM 104 can associate each entity with a cluster center based on the characteristic data of the entities and the location of the cluster centers. For example, each entity can be assigned to the closest cluster center in the one-or multi-dimensional space defined by the characteristic parameters. Thus, for example, if the APGFM 104 receives data about the number of employees for a number of companies and the largest company has 5000 employees and the smallest company has 1 employee, then clusters centers can be assigned with values between 1 and 5000 and each company can be assigned to a cluster center based on its number of employees. If the APGFM 104 also receives information about the location of a company, this location information can be quantified, and the companies can be assigned to cluster centers based on both their number of employees and their locations.

After the entities have been assigned to cluster centers, the APGFM 104 can refine the positioning of cluster centers and the association of entities with various cluster centers in an iterative manner and can ensure that each cluster center is assigned a number of entities that meets the minimum size threshold (m).

In the example of FIG. 1, a remote client 101 can communicate with a communications agent 102. The client 101 may transmit characteristic parameters defining an entity for benchmarking to the communications agent 102, may transmit key performance indicator (KPI) data used to generate benchmarking data, or the client 101 may request benchmarking data from the communications agent 102. The communications agent 102 can include a secure anonymous gateway 108 and a secure authenticated gateway 110. The secure anonymous gateway 108 can communicate with the client 101 anonymously in such a way that no identifying information accompanies the transmission, and is can be used to receive characteristic parameters of entities anonymously from the client 101. For example, a user at a company may log in to the secure anonymous gateway 108 to transmit a list of confidential data about characteristic parameters including characteristic KPI characterizing the company to the system 100, so that the company can be assigned to a peer group for benchmarking. The client can also transmit KPI data that can be used to generate benchmarking data for the peer group to which the company is assigned. In response, the secure anonymous gateway 108 may transmit an encrypted identifier string to the client 101 to allow the client to retrieve statistical benchmarking data for the peer group that have been generated based on the KPI data for the companies in the peer group.

The secure authenticated gateway 110 can communicate with the client 101 in an authenticated manner and can be used to exchange information with the client 101 for which the identity of the client is needed. For example, the secure authenticated gateway 110 can be used to exchange billing information between the communications agent 102 and the client 101.

Characteristic parameters of entities can be passed by the communications agent 102 to a parameter processing module 112 that mediates the deposit of the parameters describing an entity into storage. For example, the parameter processing module 112 may receive a list of characteristic parameter data characterizing a company from the client 101 via the secure anonymous gateway 108 of the communications agent 102.

The system 100 can include a database 116 that stores characteristic parameter data received from the parameter processing module 112, as well as data about peer groups, peer group assignments, and statistical benchmarking data. For example, the database 116 may store KPI data for a company alongside KPI for a multitude of other companies, peer group assignments for every company that participates in the benchmarking service, aggregate benchmarking statistics for each peer group, and encrypted strings to match company data with their owners.

The system 100 can include an administration module 106 operatively linked to an administration database 124, where the administration module 106 manages administration criteria stored in the administration database 124 and communicates the administration criteria to components of the system devoted to peer-group formation. For example, a system administrator may store values for the desired number of peer groups (k), the minimum number of entities permitted per peer group (m) and the maximum number of entities permitted per peer group (j) in the administration database 124. These criteria then may be transmitted via the administration module 106 to other areas of the system. Of course, these criteria may be determined by an administrator using a variety of different criteria. For example, the desired number of peer groups could be an absolute number or a relative number (e.g., the desired number of peer groups could depend on the number of companies that participate in the benchmarking service offered by the provider of the system 100).

The APGFM 104 can read administration criteria from the administration module 106 as well as stored characteristic parameter data from the database 116 and can use this characteristic parameter data to assign entities to peer groups that conform to the criteria. For example, the APGFM 104 may load a number of clusters (k), a minimum threshold size (m), and characteristic parameter data for a set of companies, and assign k cluster centers to the companies such that no cluster contains fewer than m companies. After receiving the characteristic parameter data for the entities participating in the benchmarking service and the criteria to which the peer groups must conform, the APGFM 104 can automatically generate peer groups and assign entities to the peer groups with several modules, described in more detail below.

The APGFM 104 can include a clustering engine 118, a thresholding filter 120 and a refining engine 122. The clustering engine 118 assigns entities to cluster centers according to the entities' parameters, then performs an iterative process wherein each cluster center is adjusted according to the parameters of the entities assigned to it, and entities are reassigned among the adjusted cluster centers. For example, the clustering engine 118 may randomly assign a set of 100 entities, each characterized by five parameters, to 10 cluster centers, with each entity and each cluster center representing a point in five-dimensional space. In the example given, the clustering engine 118 may then adjust each cluster center to reflect the average of all entities assigned to it, reassign entities to the closest cluster centers, and repeat this process until the cluster centers stabilize (i.e., , until the position of cluster centers do not change appreciably between successive iterations).

The thresholding filter 120 assesses clusters with respect to administrative criteria. For example, the thresholding filter 120 may examine cluster centers and identify those to which fewer than m entities have been assigned, where m is the minimum number of entities permitted in a cluster as given by administrative criteria. In another example, the thresholding filter 120 may examine cluster centers and identify those to which more than j entities have been assigned, where j is the maximum number of entities permitted in a cluster as given by administrative criteria.

When the thresholding filter 120 can identify a cluster that violates one or more of the administrative criteria, it can invoke the refining engine 122. The refining engine 122 can modify the assignment of entities to clusters, and can also modify the total number of clusters k by splitting a single cluster into two. For example, in a case where the minimum number of entities per cluster is denoted by m, the thresholding filter 120 may pass a cluster containing m−1 entities to the refining engine 122. The refining engine 122 may then transfer an entity from a nearby cluster to the cluster in question, thereby increasing the number of entities in the cluster in question to m and decreasing the number of entities in the adjacent cluster by 1. In another example, in a case where the maximum number of entities per cluster is denoted by j, the thresholding filter 120 may pass a cluster containing j+1 entities to the refining engine 122. The refining engine 122 may then partition the cluster in question into two daughter clusters and distribute among the two daughter clusters the entities previously assigned to the cluster in question, thereby increasing the total number of clusters k. The refining engine 122 is operatively connected to the administration module 106, so as to communicate changes to the total number of clusters k as a result of partitioning a cluster that has grown too large.

In this manner, the APGFM 104 produces stable cluster centers that characterize the entities being processed, their parameters, and the administrative criteria. The APGFM 104 then assigns peer groups to these cluster centers, such that entities assigned to a particular cluster center are said to be members of the corresponding peer group.

Peer groups, cluster center locations, and entity assignments are stored by the APGFM 104 in the database 116 for benchmarking and retrieval. To accomplish this, the system contains a benchmarking engine 114. The benchmarking engine 114 retrieves from the database 116 the list of entities and their parameters, peer group assignments and aggregate data for parameters across entire peer groups, and generates benchmarking data by comparing an individual entity's parameters against those of the peer group to which it is assigned. For example, the benchmarking engine 114 may retrieve the KPI characterizing the performance of a company, and the aggregate KPI of all other companies assigned to the same peer group; the benchmarking engine 114 may then perform a comparison representing the KPI of the queried company as fractions of the aggregate KPI. The benchmarking engine 114 can also receive requests for benchmarking data from the secure authenticated gateway 110, and transmit said benchmarking data to the client via the secure authenticated gateway 110. For example, the benchmarking engine 114 may receive a request via the secure authenticated gateway 110 from a company for benchmarking data derived from KPI previously transmitted via the secure anonymous gateway 108, along with an encrypted string identifying the company. The benchmarking engine 114 then may use the encrypted string to retrieve the appropriate KPI data from the database 116 along with the peer group assignment and aggregate data of other companies assigned to the same peer group, and return benchmark data comparing the company KPI to peer group aggregate KPI to the client 101 via the secure authenticated gateway 110.

As noted above, the system preserves confidentiality of data, particularly parameters defining entities to be grouped into peer groups. A key concern in benchmarking is ensuring anonymity of individual data. For example, a company participating in benchmarking studies with competitors may wish to learn how its KPI compare with those of competitors, but it should not be able to deduce the ownership of any particular KPI or otherwise identify data about a specific competitor from the aggregate statistics. To ensure such anonymity, each entity must belong to exactly one peer group, and each peer group must meet a minimum size threshold (m). The system shown in FIG. 1 preserves entity anonymity through the separation of parameter input to the parameter processing engine 112 and retrieval of benchmarking data by the benchmarking engine 114, and through a secure anonymous gateway 108 for contribution of parameter data. In an example implementation, parameters may be identified within the system by an encrypted string, a duplicate of which is passed to the contributing client upon successful uploading of parameters via the secure anonymous gateway 108. When the client seeks to retrieve benchmark data, they log in via the secure authenticated gateway 110 and transmit this encrypted string, which is then used internally to retrieve the relevant peer group and aggregate data for benchmarking.

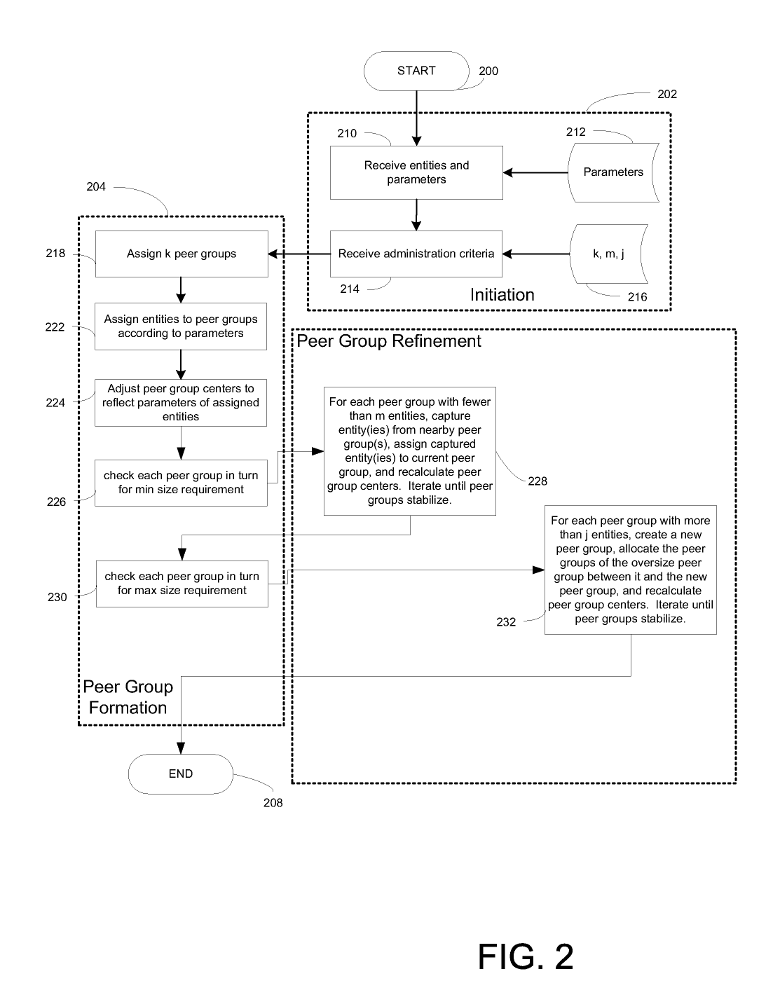

FIG. 2 is a schematic flowchart of various techniques that can be used for automatically generating peer groups of entities for benchmarking, which can be performed by the APGFM 104 (FIG. 1) using as input characteristic parameters of a multitude of entities, while preserving a minimum peer group size. Three main stages are illustrated in FIG. 2, which take place within the APGFM 104: initiation (202), peer group formation (204) and peer group refinement (206).

When the APGFM 104 is invoked to assign peer groups to a set of entities, a process begins (step 200) with the APGFM retrieving characteristic parameter information about the entities to be clustered into peer groups, and administration criteria that determine how clustering should proceed (step 202). Data about entities, which retains the anonymity of the entities, and data about the characteristic parameters associated with the entities can be retrieved (step 210) from storage (212). For example, a list of companies and their associated characteristic parameters, including key performance indicators (KPI), may be retrieved from storage in the database (116). Administration criteria can be received (step 214) from the administration module (216). The administration criteria shown in the example of FIG. 2 can include the desired number of peer groups (k), the minimum number of entities per peer group (m), and the maximum number of entities per peer group (j). In some implementations, the number of peer groups (k), can be determined based on the number of entities that will be groups into peer groups, and the minimum and maximum number of entities per peer group.

Following the receipt of data about the entities to be grouped, their characteristic parameters and the administration criteria, peer groups can be formed (as in routine 204). This peer group formation process can begin with the creation of a multitude of peer groups, to which entities will be assigned (218). For example, if 100 entities to be grouped are each characterized by five parameters, and the administration criteria specify 10 peer groups (k=10), the entities can be arranged as 100 points in five-dimensional space as defined by the characteristic parameters upon which the peer groups are based, and 10 peer groups can be created in five-dimensional space. To begin the process of peer group creation, k cluster centers can be assigned in the five-dimensional space. The cluster centers can be located with the five-dimensional space using a variety of different algorithms, including random assignment, assignment at equal distances from each other, pseudo-random assignment, or any other positioning algorithm. The number of entities in each peer group is not fixed at this time.

Then, entities can be assigned to peer groups according to their characteristic parameters (step 222). For example, if 100,000 entities to be grouped are each characterized by 100 parameters, and the administration criteria specify that an average number of entities in a peer group be equal to 50 (i.e., the total number of peer groups should, k, equals 2000), the 100,000 entities will each be assigned to the nearest of 2000 peer groups in 100-dimensional space, such that each entity is assigned to exactly one peer group and each peer group may have zero, one, or more than one entity assigned to it.

The centers of peer groups can be (re)computed to reflect characteristic parameters of the entities assigned to them (step 224). For example, the coordinate location of a cluster center for a peer group in 100-dimensional space may be (re)computed as the average of the parameters of all entities assigned to that peer group. Different weightings can be assigned to the different characteristic parameters, so that the cluster center is located at a weighted average of the parameters of all entities assigned to the group. Weighted averages can be used to assign relatively greater emphasis to some characteristic parameters than others when assigning entities to peer groups. By recomputing the cluster centers of the peer groups, cluster centers for peer group can be updated to reflect the latest complement of entities assigned to them, and when entity assignments change, so can the locations of the peer group cluster centers.

After the initial assignment of entities, peer groups can be refined by imposing the administration criteria in two refinement steps. First, each peer group can be checked to verify whether the group currently being examined conforms to the minimum size requirement for number of entities assigned (step 226). If a peer group does not meet the minimum size requirement set forth in the administrative criteria, an entity can be transferred from a neighboring peer group to the peer group in question, and cluster centers of the assignor and assignee peer groups can be recomputed in light of the newly assignment of entities (step 228). For example, if the administration criteria specify that the minimum number of entities permissible per peer group is 50, and the peer group under consideration in the loop 220 has 49 or fewer entities assigned, an entity may be captured from a nearby peer group and assigned to the peer group under consideration. As described in more detail below, this step can be iterated until the peer groups stabilize.

After entities have been assigned to peer groups, such than each peer group meets the minimum size requirement set forth in the administrative criteria, it can be verified whether each peer group conforms to the maximum size requirement for the number of entities assigned (step 230). Each peer group that does not meet the maximum size requirement set forth in the administrative criteria can be partitioned into two daughter peer groups, the entities previously assigned to the peer group can be assigned to the new daughter peer groups, and the centers of the daughter peer groups can be recomputed (step 234). For example, if the administration criteria specify that the maximum number of entities permissible per peer group is 300, and the peer group under consideration has over 300 entities assigned, the peer group may be partitioned into two daughter peer groups of 150 or more entities each. As described in more detail below, this step can be iterated to refine the assignment of entities among the two daughter peer groups.

The process can terminate (step 208) when further iterations do not modify entity assignment or the locations of peer group centers. For example, the loop may terminate (step 208) when all 100,000 entities are stably assigned to 2000 peer groups, no peer group has fewer than the minimum number of entities as set forth in the administration criteria, no peer group has more than the maximum number of entities as set forth in the administration criteria, and the locations of peer groups in the g-dimensional parameter space, where g is the number of parameters considered for each entity, remain unchanged through successive iterations of the loop. In another example implementation, the loop may terminate (step 208) when the changes in peer group position with each iteration fall below a given threshold value. In another example implementation, the loop may terminate (step 208) when no peer group has fewer than the minimum number of entities as set forth in the administration criteria.

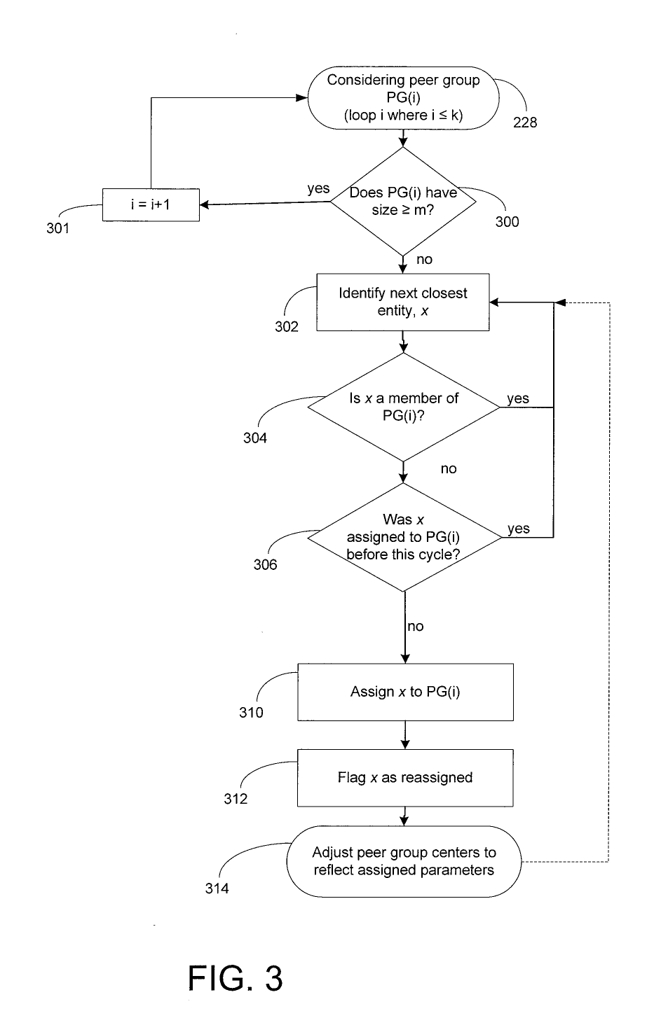

FIG. 3 is a schematic flowchart of a process involving a “greedy algorithm” for refining peer groups while ensuring that each peer group contains at least a minimum number of entities. FIG. 3 is a detail expansion of steps 226 and 228 shown in FIG. 2.

The step 228 of FIG. 2 to ensure that each peer group contains at least a minimum number of entities occurs within a loop through all peer groups. The peer group under consideration by this loop can be referenced in FIG. 3 as PG(i), where i can range from 1 to the number of peer groups, k. If the current peer group PG(i) has a sufficient number of entities assigned to it such that it satisfies the minimum size requirement, m, set forth in the administration criteria (step 300), the index, i, is incremented by one, and the next peer group is considered (step 226). For example, if peer group PG(i) has 13 entities assigned to it, and the minimum size threshold m set forth in the administration criteria is five, then the process may proceed to assess the whether the next peer group satisfies the minimum size requirement.

If peer group PG(i) does not meet the minimum size threshold, m, set forth in the administration criteria (step 300), the next closest entity, x, to the center of PG(i) is identified (step 302). For example, if peer group PG(i) has 43 entities assigned to it, and the minimum size threshold m set forth in the administration criteria is 50, then the closest entity to peer group PG(i) can be identified (step 302). It can be ascertained whether entity x is already a member of peer group PG(i) (step 304), and whether entity x was previously assigned to peer group PG(i) before the current instance of the loop (step 306). If any of these conditions test positive, the next closest entity is sought (step 302). These tests can be repeated until an entity x is identified which does not violate any of the criteria. This entity x then can be assigned to peer group PG(i) (step 310), thereby increasing the number of entities assigned to this peer group by one. Entity x can be flagged as having been reassigned, noting the peer group from which it was taken in this reassignment step (step 312). The process then can adjust the cluster centers of the donor and donee peer groups to reflect the new assignment of entities (step 314). This loop can be repeated until all peer groups have at least m entities. Thus, one entity can be added to each undersized peer group, in turn, and then the loop can be cycled through again to determine whether further reassignment of entities is necessary to address undersized peer groups. This can be repeated until all peer groups have at least m entities. In some implementations, (as shown by the dashed line in FIG. 3) after a new entity has been assigned to the peer group, PG(i), and the centers of the donor and donee peer groups has been recomputed, it can again be considered whether the PG(i) has at least m entities. In such implementations, entities can be reassigned to the peer group under consideration, PG(i), until PG(i) satisfies the minimum size requirement.

The greedy algorithm described in, and with reference to, FIG. 3 can gather nearby entities whenever a given peer group falls below the minimum size threshold, m. Provided the nearest entity has not just been reassigned from the peer group under consideration, if entity x is removed, entity x is reassigned to the current peer group. (These requirements exist to prevent iterative capturing and recapturing of the same entity by two adjacent peer groups). Including this algorithm within the larger clustering algorithm used to generate peer groups ensures no empty peer groups exist, no peer groups exist with too few entities for meaningful benchmarking (a company seeking to benchmark its KPI against competitors, for example, does not benefit from being placed in a peer group containing itself alone), and no peer groups exist with sufficiently few entities assigned that the ownership of individual parameters can be deduced from the aggregated benchmarking data. In this manner, the benchmarking system preserves anonymity among users or subscribers, while ensuring each subscriber a useful and meaningful peer group against which to benchmark. Moreover, the greedy algorithm can be implemented in a dynamic programming form, providing a fast method of ensuring that peer groups comply with minimum thresholds while enabling rapid clustering of a large number of entities and enhancing the user experience.

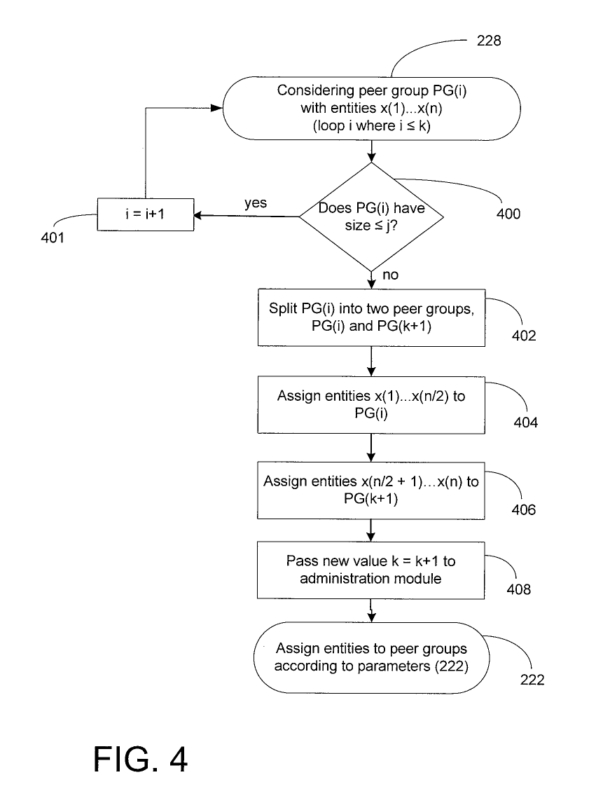

FIG. 4 is a schematic flowchart detailing a process for refining peer groups while preserving a maximum peer group size and provides an expansion of steps 230 and 232 shown in FIG. 2. The minimum threshold step (step 232 shown in FIG. 2) can occur after all peer groups have been refined such each group contains at least m entities and can occur within a loop through all peer groups. The peer group under consideration by this loop is referenced in FIG. 4 as PG(i), where i can range from 1 to the number of peer groups, k, and the entities assigned to PG(i) are referenced as x(1) . . . x(n) where n is the number of entities assigned to PG(i). If the current peer group PG(i) has sufficiently few entities assigned to it that it satisfies the maximum size requirement j set forth in the administration criteria (step 400), the process can increment the variable i (step 401) and examine the next peer group PG(i+1) (step 232). For example, if peer group PG(i) has 97 entities assigned to it, and the maximum size threshold j set forth in the administration criteria is 300, then the process may proceed to increment the loop (step 401).

If peer group PG(i) does not satisfy the maximum size threshold, j, set forth in the administration criteria (step 400), the peer group PG(i) can be split into two peer groups, referenced in FIG. 4 as PG(i) and PG(k+1) (step 402). The entities previously assigned to PG(i) can be divided equally among the new peer groups where possible, and with a difference of ±1 entity between peer groups where an odd number of entities was previously assigned to PG(i) (steps 404 and 406). For example, if peer group PG(i) has 301 entities assigned to it, and the maximum size threshold j set forth in the administration criteria is 300, then peer group PG(i) can be partitioned into two new peer groups (step 402), with 151 entities are assigned to one of the two new peer groups PG(i) (step 404) and the remaining 150 entities are assigned to the other of the two new peer groups PG(k+1) (step 406). The administration criterion for the total number of peer groups, k, can be incremented by one, and this new value of k can be passed to the administration module (step 408).

The net effect of splitting peer groups when they become too large (as defined by the maximum size parameter, j) is to force large peer groups to be divided and resorted, thereby creating better and more accurate peer groups. Just as peer groups with one entity are useless for benchmarking, and similarly peer groups with very few entities are of limited use, so too are peer groups overburdened with a large plurality of entities. Benchmarking depends upon the identification of appropriate standards against which to measure performance, and attempting to measure performance against a very large conglomeration of entities may suggest that a larger number of peer groups is required. The optimal number of peer groups can be one that achieves an accurate representation of the distribution and characteristics of entities, and an overfull peer group suggests that the assigned entities can be partitioned further and characterized more fully by splitting the group and clustering further.

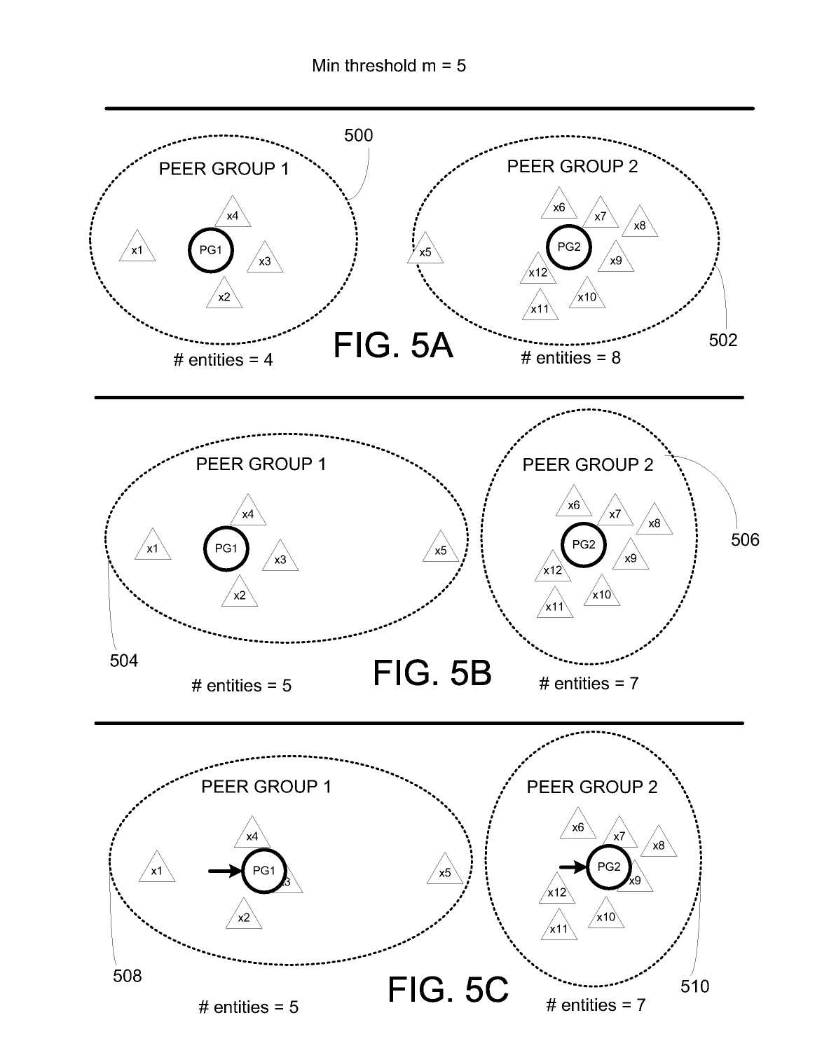

FIGS. 5A, 5B, and 5C are schematic diagrams showing the evolution of a peer groups as they are refined by the greedy algorithm described above according to a process by which thresholds are enforced on minimum peer group size. In the example of FIG. 5A, a first peer group 1 (500) has four entities assigned (x1 . . . x4) and the center of the peer group has been calculated as the average of the assigned entities in 2-dimsensional space, whereas a second peer group 2 (502) has eight entities assigned (x5 . . . x12). In the example of FIGS. 5A, 5B, and 5C, the minimum permissible threshold value for the number of entities assigned is set at m=5. As such, the first peer group (500) shown in FIG. 5A has too few entities assigned and does not satisfy the minimum size requirement of m=5. However, according to the process outlined in FIG. 2 and detailed in FIG. 3, a nearby entity, x5, can be captured from the neighboring second peer group (502) and added to the peer group (500). In order to identify entity, x5, and reassign it to the first peer group, the entity, x5, must not be already assigned to the first peer group, and the last assignment of the entity, x5, before being assigned to the second peer group (502) must not have been the first peer group (500). Since both conditions are met in the example shown in FIG. 5A, then, as shown in FIG. 5B, the entity, x5, is reassigned from the second peer group (506) to the first peer group (504). This changes the number of assigned entities in the first peer group to five, and in the second peer group to seven. Then, as shown in FIG. 5C, the change in the assignment of entities to the two peer groups is reflected in the position of the cluster centers of the first (508) and second (510) peer groups, as their locations are computed taking into account the parameters of all assigned entities. The net effect of the operation is to remedy the insufficient number of entities assigned to the first peer group by increasing the number of entities associated with the first peer group by one, transferring a nearby qualifying entity from a peer group with sufficient entities assigned to one without.

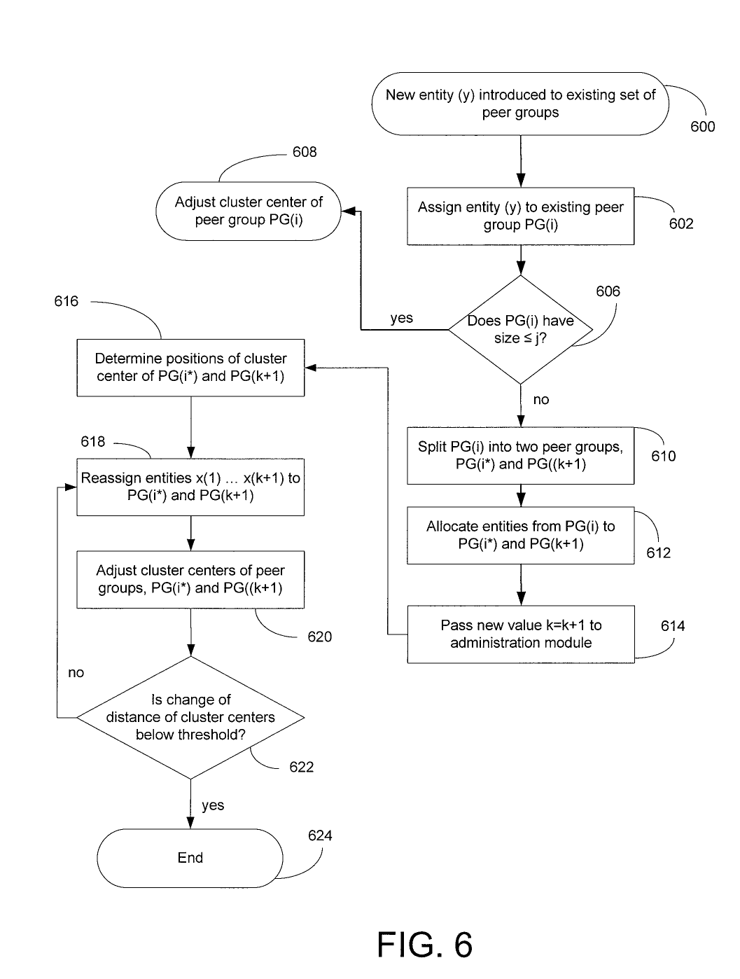

FIG. 6 is a schematic flowchart illustrating a process by which incremental entities are added to existing peer groups without the need to recalculate every peer group. Once a stable set of peer groups has been produced, entities still may be introduced incrementally to the benchmarking system. These entities can be assigned to appropriate peer group without necessitating recalculation of every peer group by means of an incremental peer group processing process, an example of which is shown in FIG. 6.

In the process, a new entity (y), carrying with it a set of characteristic parameters, is introduced to an existing set of peer groups (step 600). The new entity (y) is assigned to an appropriate peer group based on the values of its characteristic parameters and the value of the cluster center of the appropriate peer group. For example, if the new entity (y) is characterized by five characteristic parameters, and the administration criteria specify 10 peer groups (k=10), the new entity (y) may be assigned to the nearest of the 10 peer groups in the five-dimensional space, such that the total number of entities assigned to this peer group is increased by one.

The peer group to which the new entity (y) is added is referenced in FIG. 6 as PG(i), where the index value, i, can range from 1 to the number of peer groups, k, and the number of entities assigned to PG(i) are referenced as x(1) . . . x(n), where the index value, n, is the number of entities assigned to PG(i) before the introduction of new entity (y). Upon assignment to PG(i), the new entity (y) becomes associated with PG(i) as entity x(n+1) in PG(i) (step 602). If the target peer group, PG(i), has sufficiently few entities that it satisfies the maximum size requirement set forth in the administration criteria (i.e., n+1≦j) the cluster center of PG(i) is recalculated to reflect the newly assigned entity, x(n+1) (step 608). For example, if entities characterized by five parameters are clustered into peer groups in five-dimensional space, and a new peer group is added to the nearest per group, the center of the peer group to which the new entity is added may be adjusted to the (weighted) average of all assigned entities in the five-dimensional space without adjusting other existing peer group centers or entity assignments.

If, upon the addition of the new entity (x+1) to PG(i), the peer group PG(i) no longer satisfies the maximum size requirement, j, set in the administrative criteria (step 606), PG(i) can be split into two peer groups, PG(i*) and PG(k+1) (step 610). The entities previously assigned to PG(i), including the newly added entity, x(n+1), can be divided between the new peer groups (e.g., with half, or approximately half, the entities being assigned to each new peer group) (step 612). For example, if peer group PG(i*) has 301 entities assigned to it, and the maximum size threshold j set forth in the administration criteria is 300, then peer group PG(i*) can be partitioned into two new peer groups, with 151 entities being assigned to one of the two new peer groups PG(i*) and the remaining 150 entities being assigned to the other of the two new peer groups PG(k+1). The administration criterion for the total number of peer groups, k, can be incremented by one, and this new value of k can be passed to the administration module (step 614).

Because the reassignment of entities x(1) . . . x(n+1) previously assigned to PG(i) to PG(i*) and PG(k+1) can be arbitrary, the new assignments may not initially reflect an optimal clustering of entities in the new peer groups. An iterative loop can be performed to refine the peer group assignments of entities x(1) . . . x(n+1) between the new peer groups. It should be noted that the reassign of no other entities and the calculation of no other cluster centers is performed at this time, which results in fast integration of a new incremental entity, even when the addition of such new entities necessitate revisions to individual peer groups. In the loop, the position of the cluster centers of the new peer groups is determined (step 616), and entities, x(1) . . . x(n+1), are reassigned to the peer groups, PG(i*) and PG(k+1), according to their characteristic parameters and the values of the peer groups' cluster centers (step 618). The peer groups' cluster centers are the adjusted to reflect the characteristic of the entities reassigned to each peer group (step 620). Then, the change in the cluster center positions since the last iteration is compared to a threshold value (step 622). This loop repeats until the cluster centers of the new peer groups stabilize. For example, in one embodiment, the loop can terminate (step 624) when no further change in the positions of the cluster centers occurs between successive iterations or when the change in the positions of cluster centers between iterations is below a threshold value.

After the new entity has been assigned to the appropriate peer group and the peer group to which the new entity is assigned has been adjusted to reflect the characteristic parameters of the new entity and all previously-assigned peer groups, the process terminates. Specifically, the process terminates (step 624) when the new entity has been assigned to the appropriate peer group, the peer group has been partitioned, if necessary, and the resulting peer group(s) have been adjusted to reflect the addition of the new entity and the new set of associated entities, if applicable. Because an entity introduced to a stable set of peer groups is assigned to an existing peer group according to its characteristic parameters and the aggregate parameters of other entities already assigned to the given peer group, it is not necessary to recalculate every peer group in the benchmarking system whenever a new peer group is added. This is especially beneficial when adding a new entity to a system that includes a large number of entities and a large number of peer groups. For example, a service provider that provides a benchmarking service to thousands to hundreds of thousands of entities is able to process and include additional client entities as the entities sign up for the service, without the computationally costly task of reassigning every entity to a new peer group. This marginal refinement of the peer groups contributes to the overall speed with assigning entities to peer groups and providing a useful benchmarking service.

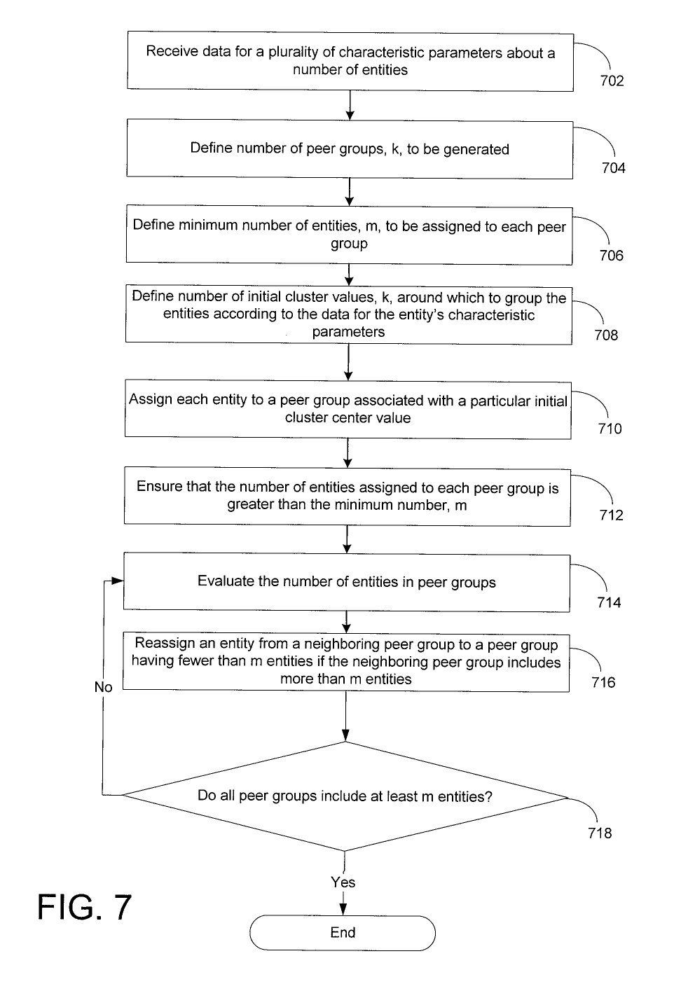

FIG. 7 is an example flowchart of a process of automatically generating peer groups of entities. In the process data for a plurality of characteristic parameters about a number of entities are received (step 702). For example, the data the characteristic parameters can be received through the secure anonymous gateway 110 of the communications agent 102. A number of peer groups, k, to be generated can be defined (step 704). For example, the number of peer groups can be defined based on criteria imposed by the administration module 106. A minimum number of entities, m, to be assigned to each peer group can be defined (step 706). For example, m can be defined based on criteria imposed by the administration module 106 or based on the number of entities that communication characteristic information through the gateway 110. A number of initial cluster values, k, can be defined around which to group the entities according to the data for the entity's characteristic parameters (step 708). Each entity can be assigned to a peer group associated with a particular initial cluster center value (step 710), for example, by the clustering engine 118. In addition, it can be ensured that the number of entities assigned to each peer group is greater than the minimum number, m (step 712). For example, in one implementation, the clustering engine 118 can assigns entities to peer groups such that the number of entities in each peer group is greater than the minimum number. In another example implementation, the number of entities in peer groups can be evaluated (step 714) (e.g., by the refining engine 122), and an entity from a neighboring peer group can be reassigned to a peer group having fewer than m entities if the reassigned entity has not previously been assigned to the peer group having fewer than m entities. The evaluating and the reassigning steps can be repeated until all peer groups include at least m entities (step 718).

The example modules, filters, engines, gateways, and databases shown in FIG. 1 may be implemented by separate processors, or may be implemented as executable code that may be loaded and executed by a single processor. For example, the modules, filters, engines, gateways, and databases may be implemented as software objects that may be compiled and stored in a nonvolatile memory, and may be loaded into a volatile memory for execution. For example, the modules, filters, engines, gateways, and databases may also be located on separate processors that may be distributed over a network such as local or wide area network, and may be executed in a distributed manner when needed.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the implementations.

What is claimed is:

1. A method of automatically generating peer groups of entities, the method comprising:
receiving data for a plurality of characteristic parameters about a number of entities;
defining a number of peer groups, k, to be generated;
defining a minimum number of entities, m, to be assigned to each peer group;
defining k initial cluster values around which to group the entities according to the data for the entity's characteristic parameters;
assigning each entity to a peer group associated with a particular initial cluster center value; and
ensuring that the number of entities assigned to each peer group is greater than the minimum number, m.

2. The method of claim 1, wherein ensuring that the number of entities assigned to each peer group is greater than m comprises:
evaluating the number of entities in peer groups;
reassigning an entity from a neighboring peer group to a peer group having fewer than m entities, so long as the reassigned entity has not previously be assigned to the peer group having fewer than m entities; and
repeating the evaluating and the reassigning until all peer groups include at least m entities.

3. The method of claim 2, wherein no entity is reassigned more than once.

4. The method of claim 2, wherein the assignment of each entity to a peer group associated with an initial cluster value is based on the values of the entity's characteristic parameters and the value of the initial cluster value of the peer group.

5. The method of claim 2, further comprising:
modifying cluster center values for peer groups to reflect values of the characteristic parameters of the entities assigned to the peer groups;
reassigning entities to peer groups based upon the values of the entities' characteristic parameters and the cluster center values of the peer groups, including any modified cluster center values;
refining peer groups by reassigning entities to peer groups to ensure that the number of entities assigned to each peer group is greater than the minimum number, m; and
repeating the modification of the cluster values, the reassignment of the entities to the peer groups, and the refining of peer groups until the cluster center values change by less than a threshold value during subsequent iterations, and until the number of entities assigned to each peer group is greater than the minimum number, m.

6. The method of claim 2, wherein data for the characteristic parameters comprise key performance indicators (KPI) for the entities.

7. The method of claim 2, further comprising:
after a plurality of entities have been assigned to a number of peer groups, such that the number of entities assigned to each peer group is greater than m, receiving a new entity to be added to a peer group;
assigning the new entity to an existing peer group associated with a particular cluster center value based on the new entity's characteristic parameters and the value of the particular cluster center value;
when the number of entities assigned to the existing peer group exceeds a maximum size threshold, partitioning the existing peer group into two new peer groups and assigning subsets of the entities from the existing peer group to each new peer group; and
determining a cluster center value associated with each new peer group.

8. The method of claim 2, wherein the initial cluster values are assigned randomly within bounds defined by highest and lowest values of the characteristic parameters.

9. The method of claim 2, further comprising:
receiving KPI data for entities;
analyzing the KPI data to generate benchmark data for a peer group having at least m entities; and
providing the benchmark data to entities in the peer group.

10. The method of claim 9, wherein defining a minimum number of entities, m, to be assigned to each peer group comprises defining m to be sufficiently large such that a KPI data value for an entity in a peer group cannot be determined from an average of the KPI data values for all entities in the peer group.

11. The method of claim 9, wherein the number of entities assigned to each peer group is greater than 3.

12. The method of claim 9, wherein the KPI data is received anonymously.

13. A system for automatically generating peer groups of entities, the apparatus comprising:
a communications agent adapted to receive characteristic parameter data about entities from remote clients;
a clustering engine adapted to generate cluster center values, assign entities to cluster centers to create peer groups of entities, and adjust cluster center values according to the characteristic parameters of the entities assigned to the cluster centers;
a thresholding filter engine adapted to identify peer groups that do not meet specified size thresholds;
a refining engine adapted to reassign an entity from a neighboring peer group to a peer group that does not satisfy a minimum size threshold if the reassigned entity has not previously been assigned to the peer group that does not satisfy the minimum size requirement.

14. The system of claim 13, wherein the communications agent comprises a secure anonymous gateway for the transfer of characteristic parameter data and key performance indicator data for an entity.

15. The system of claim 13, wherein the refining engine is further adapted to:
evaluate the number of entities in different peer groups;
reassign an entity from a neighboring peer group to a peer group that does not satisfy the minimum size threshold if the reassigned entity has not previously been assigned to the peer group that does not satisfy the minimum size requirement; and
repeat the evaluating and the reassigning until all peer groups satisfy the minimum size threshold, while not reassigning an entity back to a peer group from which the entity was already reassigned.

16. The system of claim 16, wherein the refining engine is further adapted to modify cluster center values after reassigning an entity from a neighboring peer group to a peer group that does not satisfy the minimum size threshold.

17. The system of claim 13, wherein the communications agent is further adapted to receive a new entity to be assigned to a peer group after a plurality of entities have been assigned to a number of peer groups, such each peer group satisfies the minimum size threshold;
wherein the clustering engine is further adapted to assign the new entity to an existing peer group associated with a particular cluster center value based on the new entity's characteristic parameters and the value of the particular cluster center value; and
wherein, when the number of entities assigned to the existing peer group exceeds a maximum size threshold, the refining engine is further adapted to partition the existing peer group into two new peer groups, assign subsets of the entities assigned to the existing peer group to each new peer group, and determine a cluster center value associated with each new peer group.

18. The system of claim 13, wherein the communications agent is further adapted to receive key performance indicator (KPI) data about the entities from the remote clients, and the system further comprising a benchmarking engine adapted to statistically analyze KPI data for entities in a peer group to generate benchmark information for the entities in the peer group.

19. The system of claim 18, further comprising an administration module adapted to set the minimum size threshold, such that the number of entities assigned to each peer group that satisfies the minimum size threshold is sufficiently large such that a KPI data value for an entity in a peer group cannot be determined from an average of the KPI data values for all entities in the peer group.

20. The system of claim 18, wherein the communications agent is adapted to receive the KPI data anonymously.
